(19) United States
(12) Patent Application Publication
(10) Pub. No.: US 2010/0055371 A1
(43) Pub. Date: Mar. 4, 2010

(54) Multi-Layer Dry Paint Transfer Laminate Having Olefinic Release Layer and Water-Based Opaque Layer

(76) Inventors: David N. Edwards, Pasadena, CA (US); Frank Y. Shih, Arcadia, CA (US); Chia-Hsi Chu, Arcadia, CA (US)

Correspondence Address: AVERY DENNISON CORPORATION;Patent Group, Law Department - 3 South, P.O. BOX 7090, PASADENA, CA, 91109-7090, US

(21) Appl. No.: 12/204,577

(22) Filed: Sep. 4, 2008

(51) Int. Cl. B32B 33/00; B41M 3/12

(52) U.S. Cl. 428/41.6; 427/146

(57) ABSTRACT

A multi-layer dry paint transfer laminate includes a release liner in which a flexible carrier is provided with an olefinic release layer; a dry paint transfer layer includes an opaque color coat layer formed from a pigmented, water-based latex, a transparent top coat layer, and a decorative print layer; and a PSA layer. A method of making an improved laminate is also provided.

### FIELD OF THE INVENTION

This invention relates to dry paint transfer laminates, particularly decorative laminates for applying a layer of color to an architectural surface, such as a wall.

### BACKGROUND OF THE INVENTION

Thin sheets of decorative, multi-layer laminates are used as an alternative to paint on a number of substrate surfaces, including walls and other architectural surfaces. A typical laminate includes a paint transfer film, one side of which is releasably adhered to a protective liner, the other side being adhered to an adhesive capable of securing the laminate to a substrate surface, such as a wall. The dry paint transfer film typically includes a number of individual layers, including an opaque color coat layer, a top coat layer (which can impart a matte-like finish, abrasion resistance, and/or other properties to the final paint laminate), a decorative print layer (which allows a pattern to be provided, such a wood grain or other faux finish), and optionally one or more additional layers. A barrier layer is sometimes provided, e.g., between the adhesive layer and the paint transfer layer, to reduce migration of color-degrading compounds through the adhesive layer into the paint layer. Designed to mimic paint in both appearance and feel, such laminates are quite thin, yet have enough structural integrity to allow the laminate to be handled as it is dispensed from a roll, applied to a surface, repositioned if necessary, and secured to the substrate surface.

In the past, dry paint transfer laminates have often used solvent-borne polymeric binders as a medium for carrying a pigment within the paint coat layer. However, solvent-based systems have a number of disadvantages, including odor, higher viscosities, the need for specialized coating equipment (which can be slower to operate), etc. In addition, known release systems for protecting the paint transfer portion of the laminate have not fully utilized useful techniques for applying an opaque color coat layer to a release liner, such as direct casting, by coating or printing, of an opaque color coat layer onto an olefinic release surface. Despite the advances made in the field of dry paint transfer laminates, there remains a need for improved laminates and methods of manufacture.

### SUMMARY OF THE INVENTION

The present invention provides a multi-layer laminate for applying a layer of color to a substrate surface, such as an architectural surface. The laminate comprises an improved release liner, a flexible, dry paint transfer layer that includes a water-based color coat layer, and a pressure-sensitive adhesive layer. In one embodiment, the release liner comprises a flexible carrier and an olefinic release layer adhered to or integral with the carrier; the dry paint transfer layer has an inner surface and an outer surface and is coated on and releasably adhered to the olefinic release layer, and comprises, as at least one component, an opaque color coat layer formed from a pigmented, water-based latex; and a pressure-sensitive adhesive layer overlays the inner surface of the dry paint transfer layer. The olefinic release layer is adapted to separate from and expose the outer surface of the dry paint transfer layer when the release liner is peeled away from the dry paint transfer layer. The release liner surface opposite the olefinic release layer functions as a PSA release layer, and protects the PSA when the laminate is self-wound into roll form, until the laminate is applied to a substrate surface.

Advantageously, the water-based latex allows the color coat layer to be coated on the release liner using high speed coating equipment and techniques, potentially even simultaneously with the adhesive layer. In addition, water-based pigment dispersions are less expensive than organic solvent-based pigment dispersions and, since no plasticizer is needed, the resulting laminate should have better dimensional stability. Compared to some decorative laminates, the laminate of the present invention should have lower residual solvents, even in the top coat layer, which is physically constrained by the olefinic release layer until use. In addition, the olefinic release layer permits the paint transfer layer to be coated directly onto a polyester release liner, such as a polyethylene terephthalate (PET) carrier film.

These and other aspects of the invention will be more fully understood by referring to the following detailed description and the accompanying drawings.

### BRIEF DESCRIPTION OF THE DRAWINGS

FIG. 1 is a schematic cross-sectional view illustrating one embodiment of a multi-layer laminate according to the invention;

FIG. 2 is a schematic illustration of the multi-layer laminate of FIG. 1, self-wound into roll form; and

FIG. 3 is a schematic illustration of a method for making a multi-layer laminate according to one embodiment of the invention.

### DETAILED DESCRIPTION

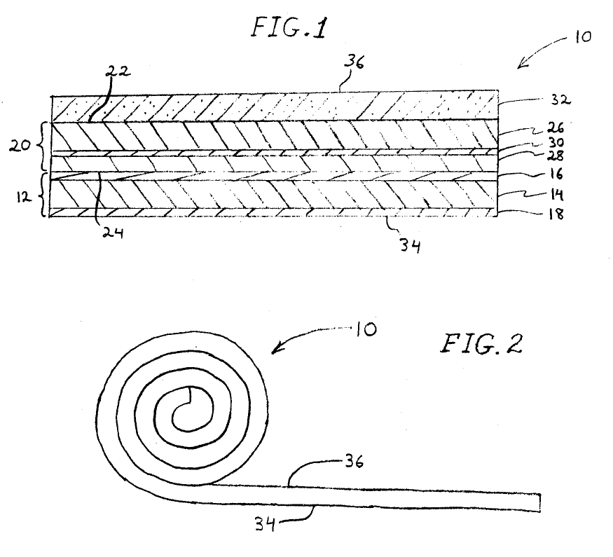

Referring to FIG. 1, a multi-layer laminate 10 according to one embodiment of the invention is shown, the laminate being adapted for use as a surfacing film. The laminate 10 includes a release liner 12 comprising a flexible carrier or backing 14 and an olefinic release layer 16 on one surface thereof. A silicone coating 18 or other PSA release material is provided on the opposite surface of the carrier 14. A flexible, dry paint transfer layer 20, having an inner surface 22 and an outer surface 24, overlies the release liner 12. The dry paint transfer layer includes, as subcomponents or individual layers, an opaque color coat layer 26 formed from a pigmented, water-based latex as described below, a transparent top coat layer 28; and a decorative print layer 30. A pressure-sensitive adhesive (PSA) layer 32 overlies and is adhered to the dry paint transfer layer 20.

In FIG. 2, the multi-layer laminate is shown self-wound into roll form, with the outer exposed surface 34 of the release liner 12 in releasable contact with the outer surface 36 of the adhesive layer 32. Thus, when the laminate is unwound, the outer surface 34 of the adhesive layer 32 is exposed, and the laminate can be applied to a substrate surface. To use the multi-layer laminate, the laminate is unrolled, and the exposed adhesive layer is pressed against a substrate surface, repositioning it as needed. The release liner 12 is then peeled away from the decorative dry paint transfer layer 20, exposing the transparent top coat layer 28 therefrom as it releases from the olefinic release layer 16.

The portions of the multi-layer laminate applied to the substrate surface (i.e., the opaque color coat layer 26, top coat 28, decorative print layer 30, and PSA layer 32) are sufficiently thin, individually and in combination, to minimize visible seams if adjacent multi-layer laminate films are overlapped during use. In general, the overall film thickness of the laminate as applied to the wall in its finished state (omitting the release liner 12) is, preferably, less than about 3.0 mils and, more preferably, less than about 2.0 mils. In one embodiment, the multi-layer laminate has a total thickness of less than about 1.6 mils.

The dry paint transfer layer 20 has, in general, a thickness of about 0.5 to about 1.5 mils. In one embodiment, the dry paint transfer layer has a thickness of about 0.5 to about 1.2 mils, and in another embodiment a thickness of from about 0.5 to about 0.9 mils. The transparent top coat layer 28, in general, has a thickness of from about 0.05 to about 0.4 mils. In one embodiment, the top coat layer has a thickness of from about 0.05 to about 0.3 mil. The decorative print layer 28 has, in general, a thickness of about 0.02 to about 0.15 mil. In one embodiment, the decorative print layer 28 has a thickness of about 0.02 to about 0.08 mils.

In other embodiments of the invention, the laminate 10 comprises one or more additional layers of material, each with a particular function, character and thickness. For example, more than one top coat layer may be provided, in place of a single top coat layer 28. Alternatively, or in addition, two or more print coat layers, and/or even two or more color coat layers, may be provided, in place of the single decorative print coat and color coat layers 30, 26 depicted in FIG. 1. Additional layers as described, for example, in commonly owned U.S. Pat. No. 7,132,142 (e.g., a structural layer) and published in U.S. patent application Pub. No. US2005/0196607 A1 (e.g., a barrier layer), may also be provided as part of the multi-layer laminate. Both references are incorporated by reference herein in their entirety. In all such embodiments, however, it is desirable to limit the overall thickness of the laminate (excluding the release liner 12) to less than about 3.0 mils, more preferably less than about 2.0 mils.

Dry Paint Transfer Layer

As noted earlier, the dry paint transfer layer comprises, in one embodiment, an opaque color coat layer, transparent top coat layer, and decorative print layer. The latter two layers are conventional and are described, for example, in the 2005/0196607 application (¶¶37, 44 (top coat)) and the '142 patent (Col. 6, 1.28-Col. 9, 1.51, esp. Col. 9, 1.34-51 (print layer)); Col. 6, 1.28-Col. 9, 1.14 and Col. 9, 1.52-Col. 10, 1.59 (top coat). The top coat layer provides enhanced scuff resistance, stain resistance, and/or recoatability to the dry paint transfer film layer underlying it. In addition, when formulated with a silica filler (e.g.), the top coat lowers the gloss of the matte finish on the paint transfer laminate. The decorative print layer may be used to provide a faux finish, such as a “ragged” or “sponged” effect and appearance, and may be used to provide a desired print or design image, such as wood grain, a flowered design, etc.

The opaque color coat layer provides the laminate with an overall color and opacity, and is formed by adding pigment (e.g., titanium dioxide, carbon black, colored pigments) to a water-based latex that serves as a binder for the pigment when the color coat layer is dried. Typically, the pigment is provided as a dispersion, which is added to the latex to formulate the opaque color coat. As the latex dries, the individual polymer particles coalesce and form a resulting paint layer. A single polymer, polymer blends, hybrid polymers, (one formed in the presence of another, e.g.) can be used to form the latex.

A number of polymers can be utilized in the practice of the invention. Examples include vinyl acetate polymers, acrylic polymers, styrene-butadiene resins, and hybrids and/or blends thereof, so long as the polymer(s) can be formed as a water-based latex—or included as a component of water-based latex. More specific examples include polyvinyl acetate (especially if a plasticizer is present), vinyl acetate copolymers, particularly ethylene-vinyl acetate and vinyl acetate ethylene copolymers (e.g., Airflex® vinyl acetate-ethylene copolymers, from Air Products Polymers, L.P.), ethylene-modified vinyl acetate polymers (e.g., Evocar latex DA 280, from Dow Chemical); acrylic polymers (including copolymers); copolymers of vinyl acetate and one or more acrylic monomers (e.g., acrylic acid, methyl methacrylate, butyl acrylate) and/or one or more maleic monomers (e.g., dibutyl maleate, dioctyl maleate); and acrylic-styrene copolymers. In the examples below, an ethylene-modified vinyl acetate (VAE) polymer is prepared by emulsion polymerization and an acrylic copolymer (buylacrylate/methylmethacrylate/acrylic acid) is formed in the presence of the VAE polymer, resulting in a VAE/acrylic hybrid polymer latex, which is then compounded with a pigment to form a coatable color coat layer. (In the Examples, the color coat layer comprises about 70% latex, 30% pigment, by weight, before drying.)

Pressure-Sensitive Adhesive Layer

The PSA layer 32 is provided as a conventional PSA used in wall surface films and similar paint transfer applications, and bonds the dry paint transfer layer to a substrate surface, under applied pressure, typically at room temperature. Nonlimiting examples include water-based, water-borne, solvent-based, ultraviolet cured, e-beam cured, hot melt, and other PSAs. Specific examples are provided in the '142 patent and US2005/0196607 application cited above. Optionally, the adhesive layer contains one or more pigments to increase the overall opacity of the laminate and to permit the use of thinner paint film layers to achieve a desired level of opacity.

Release Liner

Another notable feature of the invention is the use of a release liner having as one surface an olefinic release layer, and, in some embodiments, an opposite surface having PSA release properties. Referring again to FIG. 1, the release liner 12 comprises a flexible carrier 14, which may be a film, paper, or other suitable material having a flexibility, thickness, and durability sufficient to be used as a release liner in a multi-layer laminate for applying color to a surface, such as an architectural surface. In one embodiment, the flexible carrier comprises a polymeric material i.e., a polymeric film. Nonlimiting examples include polyester, e.g., polyethylene terephthalate (PET).

One surface of the carrier is coated, treated, or otherwise formed with a composition having PSA release properties, i.e., that surface functions as a release material for a PSA. In one embodiment the PSA release material is a conventional silicone material. In this embodiment, the outer surface 34 of the release liner can be said to be siliconized.

The opposite surface of the flexible carrier is coated, formed with, or treated with an olefinic release layer. As used herein, the term “olefinic” simply refers to a material comprising, derived from, or based on an olefin resin, or other olefin-containing material. Nonlimiting examples include polyethylene, polypropylene, ethylene-propylene copolymers, etc. More specific examples include low density polyethylene, such as linear low density polyethylene. Yet another example is a blend of low density polyethylene and an ethylene hexene copolymer plastomer. Such a blend can be formed, e.g., as a 50/50 blend of low density polyethylene (Chevron Phillips Marflex 1017) and ethylene hexene copolymer plastimer (Exxon Mobile Exact 3139) with a coating thickness of about 0.4 mil or 6 lbs-ream.

The olefinic release layer is adhered to or integral with the flexible carrier of the release liner. In one embodiment, the olefinic release layer is coextruded onto the carrier.

As another aspect of the invention, a method of making a multi-layer laminate for use in applying a layer of color to a substrate surface is provided, and comprises the steps of providing a release liner comprising a flexible carrier and an olefinic release layer adhered to or integral with the carrier; coating onto the olefinic release layer, by casting or printing, a dry paint transfer layer having an inner surface and an outer surface and comprising, as at least one component thereof, an opaque color coat layer, the dry paint transfer layer in dry film form being releasable from the olefinic release layer; drying the dry paint transfer layer; and applying a pressure-sensitive adhesive layer to the inner surface of the dry paint transfer layer.

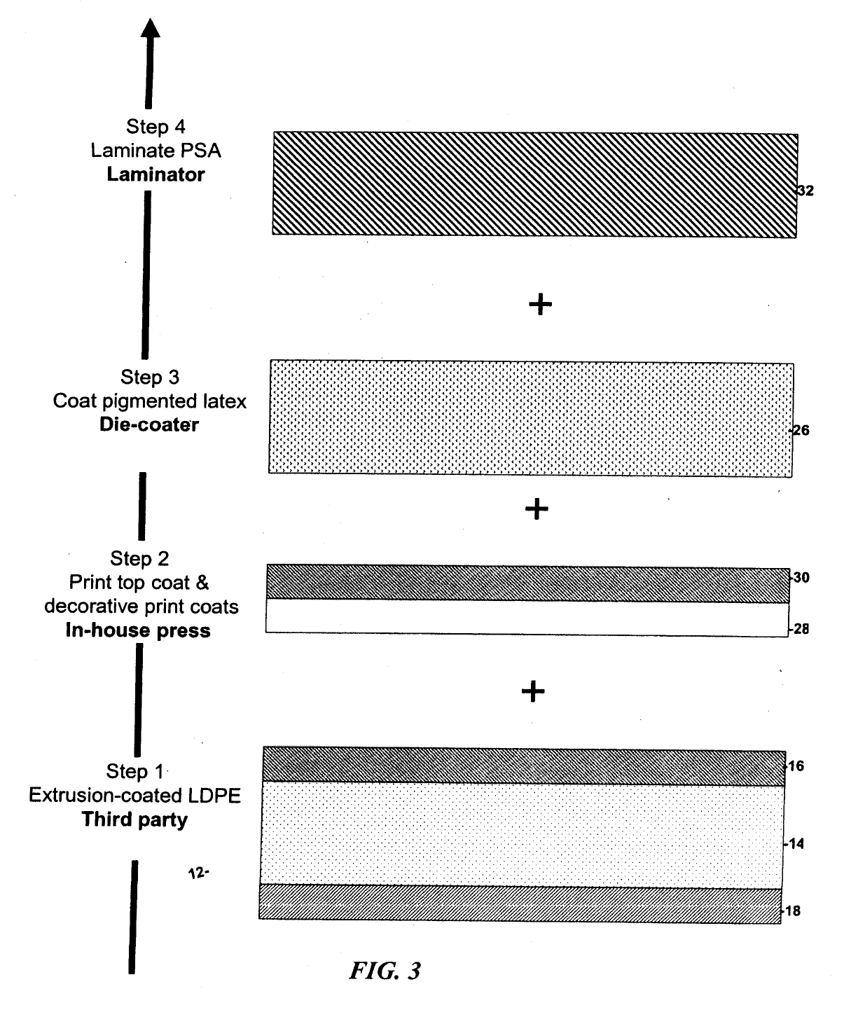

One embodiment of such a method is depicted in FIG. 3. In Step 1, a release liner 12 comprising a polyester (PET) carrier film backing 14, having an olefin release layer 16 extrusion coated on one surface and a silicone release coating 18 provided on the opposite surface, is provided as a base layer onto which additional layers are cast or laminated. In Step 2, a transparent top coat layer 28 and a decorative print coat layer 30 are coated or printed onto the olefin release layer as shown. Each of these layers is dried separately or, alternatively, the two layers are dried together prior to coating the opaque color coat layer. In Step 3, an opaque color coat layer comprising a pigmented water-based latex as described above is coated or printed onto the now dried decorative print coat layer. Such coating can take place in, e.g., a die coater at very high speeds using equipment and techniques known to those skilled in the art. Once the color coat layer is dry (e.g., by using forced air) a PSA layer 32 is laminated to the opaque color coat layer, thus completing the multi-layer laminate.

In an alternate embodiment, both the opaque color coat layer and the PSA are die-coated simultaneously, one on top of another, using a dual-die coater, such as described in Avery Dennison's U.S. Pat. No. 5,7281,430, the entire contents of which are incorporated herein by reference.

Once the laminate has been made, it can be wound up on itself to form a roll, thereby bringing the silicone release coating 18 in contact with the PSA 32, effectively protecting the PSA until the laminate is to be applied to a substrate surface, such as a wall or other architectural surface.

In another embodiment of the invention, the silicone release coating (or other PSA release material) is provided as a separate PSA release liner adhered to the PSA on the surface opposite the surface that will ultimately contact the opaque color coat layer. In this embodiment, the release liner 12 does not need to include a silicone release coating 18. Instead, the silicone release coating is provided with the PSA layer. The PSA is brought into contact with the balance of the laminate (including a dried opaque color coat layer), completing the laminate.

The following are nonlimiting examples of the invention.

Materials
Tamol 731A: A hydrophobic copolymer dispersant; excellent compatibility and good pigment wetting. Available from Rohm & Haas, Philadelphia, Pa.
Zonyl FS-300: A general purpose nonionic fluorosurfactant; ideal wetting & leveling agent for aqueous application at 40% solids. Available from DuPont, Wilmington, Del.
Kronos 4311: An aqueous dispersion of titanium dioxide at 77% solids. Available from Kronos, Houston, Tex.
Drewplus L-198: An aliphatic petroleum defoamer; available from Ashland, Columbus, Ohio.
Evocar latex DA 280: Vinyl acetate-ethylene (VAE) latex from Dow Chemical, Midland, Mich.
Triton X-405: nonionic surfactant; available from Dow Chemical, Midland Mich.
Triton X-45: nonionic surfactant; available from Dow Chemical, Midland, Mich.
Zama 7: polyaziridine; Available from Noveon, Brecksville, Ohio.

### EXAMPLE 1

### A. Preparation of a Water-Based Latex Using Seeded Emulsion Polymerization

Starting Solutions and Other Materials
A1: 273 gm of Evocar latex DA-280
A2: 1 gm water and 1 gm of Triton x-405
A3: 3 gm of butyl acrylate and 10 gm of methyl methacrylate
B1: 50 gm of water, 20 gm Triton x-405 and 1.5 gm Triton x-45
B2: 84 gm of butyl acrylate, 167 gm methyl methacrylate and 12.5 gm acrylic Acid
C: 30 gm water and 1 gm of t-butyl hydrogen peroxide
D: 30 gm water, 1 gm sodium formaldehyde sulfoxylate, 0.1 gm Triton x-405.
E. 16 gm of ammonium hydroxide at 7%
F. 0.5 gm of Drewplus L198

Polymerization Process:
1. A1 and A2 were charged to a 1-L reactor and purged with nitrogen for at least 30 minutes.
2. Start agitation and add A3.
3. Make a preemulsion of B by adding B2 to B1 under high shear mixing
4. Start heating; at 50° C. start slow-adding C and D at 3 hours rate
5. 10 minutes later, start slow-adding B at 2 hours rate at 50° C.
6. After slow-adds, continue slow-adding C and D for another 30 minutes. Then cool to less than 35° C. and discharge.
   The resulting latex (an EVA/Acrylic hybrid) has 62.7% solids, 132 cps viscosity, and 6.4 pH.

### B. Preparation of a Multi-Layer Laminate

Formulation of a Pigmented Latex

In separate containers, the following mixtures were prepared:
A1: 94.8 parts of EVA/Acrylic hybrid (Ex. 1) (100 parts dry)
B1: 32.5 parts of Kronos 4311
B2: 2 part of water and 0.3 part of Zonyl FS-300
B3: 1 part of water and 1 part of Triton x-405
C: 0.2 parts of Drewplus L-198
D: 1.6 parts of Tamol 731A
   Components B1, B2, and B3 were mixed well and added to A, and then C and D were added.

Laminate Preparation:

A solution containing polyethyl methacrylate and silica in propyl acetate was coated as a top coat layer on an extrusion-coated LDPE at 2 micron thickness. On top of this layer, a layer of pigmented latex was coated at about 1 mil. After removing the LDPE-layer, the resulting laminate has the following properties: tensile stress 12.7 Mpa, tensile strain 36%, 400 modulus, opacity 92.2% (with pigmented PSA, the opacity is 99.2%); gloss at 60 and 85 degree: 5.2 and 6.8, respectively.

### EXAMPLE 2

A pigmented latex was prepared as in Example 1 but with a mixture of 1 gm of Zama 7 in 1 gm of water also included. A laminate was prepared as described in Example 1.

Various properties of the laminate and its subcomponents are presented in Table 1, for Examples 1 and 2.

TABLE 1

| | | | Tensile | | | | | | | |
|---|---|---|---|---|---|---|---|---|---|---|
| — | — | | (At Break) | | | | Opacity (%) | | | |
| | Thickness (u) | | Stress | Strain | Modulus | Release | | Pigmented | Gloss | |
| Example | Topcoat | Color | Mpa | % | Mpa | (grams) | as is | PSA* | 60 | 85 |
| Ex. 1 | 2 | 22 | 4.5 | 10 | 385 | 34 | 90.8 | 99.37 | 6 | 8 |
| Ex. 2 | 2 | 22 | 12.7 | 36 | 400 | 46 | 91.17 | 99.22 | 5.2 | 6.8 |

*The PSA is S-3506, a crosslinked emulsion copolymer of butyl acrylate and 2-ethylhexyl acrylate, from Avery Dennison Corporation's Performance Polymers Division

What is claimed:

1. A multi-layer laminate for applying a layer of color to a substrate surface, such as an architectural surface, the laminate comprising:
a release liner comprising a flexible carrier and an olefinic release layer adhered to or integral with the carrier;
a flexible, dry paint transfer layer having an inner surface and an outer surface, coated on and releasably adhered to the olefinic release layer, the dry paint transfer layer comprising an opaque color coat layer formed from a pigmented, water-based latex; and
a pressure-sensitive adhesive layer overlying the inner surface of the dry paint transfer layer;
wherein the olefinic release layer is adapted to separate from and expose the outer surface of the dry paint transfer layer when the release liner is peeled away from the dry paint transfer layer.

2. The multi-layer laminate according to claim 1, wherein the carrier comprises a polymeric film.

3. The multi-layer laminate according to claim 1, wherein the olefinic release layer comprises low density polyethylene.

4. The multi-layer laminate according to claim 1, wherein the release liner comprises a polyethylene terephthalate film having a first surface coated with a silicone release layer and a second surface on which is extrusion coated a low density polyethylene release layer.

5. The multi-layer laminate according to claim 1, wherein the dry paint transfer layer further comprises at least one transparent top coat, which forms the outer surface of the dry paint transfer layer.

6. The multi-layer laminate according to claim 1, wherein the dry paint transfer layer further comprises at least one decorative print layer.

7. The multi-layer laminate according to claim 1 wherein the dry paint transfer layer further comprises at least one additional opaque layer.

8. The multi-layer laminate according to claim 1, wherein the water-based latex comprises at least one emulsion polymer selected from the group consisting of vinyl acetate polymers, acrylic polymers, styrene-butadiene resins, and hybrids and blends thereof.

9. The multi-layer laminate according to claim 8, wherein the water-based latex comprises a vinyl acetate copolymer or polyvinyl acetate plus a plasticizer.

10. The multi-layer laminate according to claim 9, wherein the vinyl acetate copolymer is polymerized from vinyl acetate and at least one acrylic and/or maleic monomer.

11. The multi-layer laminate according to claim 10, wherein the at least one acrylic and/or maleic monomer is selected from the group consisting of butyl acrylate, methyl methacrylate, acrylic acid, dibutyl maleate, and dioctyl maleate.

12. The multi-layer laminate according to claim 8, wherein the water-based latex comprises an acrylic-styrene copolymer.

13. The multi-layer laminate according to claim 8, wherein the water-based latex comprises an ethylene vinyl acetate copolymer/acrylic polymer hybrid.

14. The multi-layer laminate according to claim 13, wherein the acrylic polymer comprises a copolymer of butyl acrylate, methyl methacrylate, and acrylic acid.

15. A method for making a multi-layer laminate for use in applying a layer of color to a substrate surface, such as an architectural surface, the method comprising:
providing a release liner comprising a flexible carrier and an olefinic release layer adhered to or integral with the carrier;
coating onto the olefinic release layer, by casting or printing, a dry paint transfer layer having an inner surface and an outer surface and comprising, as at least one component thereof, an opaque color coat layer, the dry paint transfer layer in dry film form being releasable from the olefinic release layer;
drying the dry paint transfer layer; and
applying a pressure-sensitive adhesive layer to the inner surface of the dry paint transfer layer.

16. The method according to claim 10, wherein the dry paint transfer layer further comprises at least one top coat layer and, optionally at least one decorative print layer and/or at least one additional opaque layer.

17. A multi-layer laminate for applying a layer of color to a substrate surface, such as an architectural surface, the laminate comprising:
a release liner comprising a flexible carrier and an olefinic release layer adhered to or integral with the carrier;
a flexible, dry paint transfer layer having an inner surface and an outer surface, coated on and releasably adhered to the olefinic release layer, the dry paint transfer layer comprising a transparent top coat layer, a decorative print layer, and an opaque color coat layer formed from a pigmented, water-based latex; and
a pressure-sensitive adhesive layer overlying the inner surface of the dry paint transfer layer;
wherein the olefinic release layer is adapted to separate from and expose the outer surface of the dry paint transfer layer when the release liner is peeled away from the dry paint transfer layer.

18. A method for making a multi-layer laminate for use in applying a layer of color to a substrate surface, such as an architectural surface, the method comprising:
providing a release liner having an inner surface and an outer surface and comprising a flexible carrier and an olefinic release layer adhered to or integral with the carrier;
coating onto the olefinic release layer, by casting or printing, a dry paint transfer layer comprising a plurality of individual layers, including at least one opaque color coat layer, transparent top coat layer, and decorative print layer, the opaque color coat layer formed from a pigmented, water-based latex, the individual layers being coated sequentially;
drying the dry paint transfer layer; and
applying a pressure-sensitive adhesive layer to the inner surface of the dry paint transfer layer.

19. The method according to claim 13, wherein the plurality of individual layers are coated sequentially beginning with the transparent top coat layer(s), followed by the decorative print layer(s), followed by the opaque color coat layer(s).

20. The method according to claim 14, wherein each of the individual layers comprising the dry paint transfer layer is dried before another of the individual layers is coated.
